(19) United States
(12) Patent Application Publication
(10) Pub. No.: US 2026/0085989 A1
(43) Pub. Date: Mar. 26, 2026

(54) METHODS AND SYSTEMS FOR ACCURATE LEAK DETECTION WITH MINIMAL FALSE ALARMS

(71) Applicant: Hifi Engineering Inc., Calgary (CA)

(72) Inventors: Sahar KHAZALI, Calgary (CA); Seyed Ehsan JALILIAN, Calgary (CA); Mohammad MOSHIPOUR, Irvine, CA (US); Omid OWJIMEHR, Calgary (CA)

(21) Appl. No.: 18/898,374

(22) Filed: Sep. 26, 2024

(30) Foreign Application Priority Data
Sep. 25, 2024 (CA) 3246871

(51) Int. Cl. G01M 3/00; G06N 3/08

(52) U.S. Cl. CPC G01M 3/00; G06N 3/08

(57) ABSTRACT

Methods and systems for detecting anomalies in pipeline operational data. The methods and systems include receiving a detection signal from a sensor deployed along a pipeline and inputting the signal to an artificial neural network. The neural network includes a feature extraction model that transforms the signal into a feature map representing patterns along a temporal dimension. A temporal processing model generates states that capture temporal dependencies within the feature map. A weighting model assigns weights to these states using an attention mechanism to produce weighted representations. The network, trained with a dataset of anomalies and non-anomalies, generates a detection result by evaluating the weighted representations. As a result, leaks in pipeline operations can be accurately identified, reducing false detections.

### TECHNICAL FIELD

The present disclosure is directed to the field of pipeline monitoring, and more particularly to methods and systems for detecting anomalies of interest in pipeline operations.

### BACKGROUND

Pipelines have become an integral part of North America's infrastructure. Reliable and extensive energy distribution is critical to sustaining economic activity and meeting the region's daily energy needs. In the United States, for example, 3.3 million miles of regulated pipelines form a critical infrastructure network, and 64% of U.S. energy commodities are efficiently transported through these pipelines. Despite their undeniable utility, potential pipeline leaks are a significant concern.

A major challenge in pipeline management is the detection of anomalies. Undetected anomalies can have serious consequences, including environmental hazards, significant economic losses, and potential safety hazards. Leaks can lead to environmental disasters such as fires and serious threats to human life. For example, the Deepwater Horizon oil spill, the largest marine oil spill in history, occurred in 2010 when the Deepwater Horizon oil rig exploded in the Gulf of Mexico and sank two days later. The devastating effects of this spill resulted in the deaths of an estimated 800,000 birds, with approximately 1,400 whales and dolphins found stranded by the end of 2015. The spill also took a significant toll on local bird species, with a devastating loss of approximately 12 percent of brown pelicans and over 30 percent of laughing gulls in the affected area.

Pipeline leaks can be caused by a variety of factors, including internal corrosion resulting from chemical interactions between transported substances and pipeline materials over time, which poses an ongoing threat to the integrity of the system. Physical damage resulting from external forces such as excavation, accidental impacts, and natural disasters can also compromise the structural integrity of pipelines. In addition, operational failures such as inadequate maintenance, mishandling or procedural errors can increase the likelihood of leaks.

Given the vast expanse of many pipeline systems, manual monitoring is not only cumbersome, but often ineffective. Advanced methods for detecting anomalies in pipelines can prevent the serious consequences of leaks and ensuring the safe and efficient operation of these infrastructure systems.

### SUMMARY

According to one aspect of the disclosure, there is provided a method comprising: receiving a detection signal from a sensor deployed along a pipeline; inputting the detection signal to an artificial neural network comprising a feature extraction model that extracts from the detection signal a feature map that represents one or more patterns along a temporal dimension represented by a plurality of temporal stamps; a temporal processing model that generates from the feature map a plurality of states that capture temporal dependencies, wherein each of the plurality of states corresponds to one of the plurality of temporal stamps, and wherein the temporal dependencies represent an influence on one of the plurality of states by at least another of the plurality of states; and a weighting model that assigns a weight to each of the plurality of states to generate weighted representations of the plurality of states using an attention mechanism; and obtaining a detection result from the artificial neural network, wherein prior to receiving the detection signal, the artificial neural network has been trained to generate the detection result from the plurality of states using a training dataset comprising training signals representative of anomalies and non-anomalies in respect of the pipeline, and wherein a set of data from the training signals is labeled with a leak.

In some embodiments, the detection result may be either leak or non-leak, and data in the training dataset labeled with the non-anomaly may comprise a first set of data labeled with a non-leak activity and a second set of data labeled with noise.

In some embodiments, the weighting model may comprise a plurality of attention heads, each head configured to: calculate one or more attention scores for each of the plurality of states; normalize the one or more attention scores using a softmax function; generate one or more weights from the normalized one or more attention scores; and generate weighted representations of the plurality of states using the one or more weights.

In some embodiments, the weighted representations from each of the plurality of attention heads may be combined to form an aggregated representation, the aggregated representation being used to update the plurality of states.

In some embodiments, the weighted representations may be averaged using a mean function, and an output of the mean function may be passed through a linear layer that applies a linear transformation prior to obtaining the detection result.

In some embodiments, the method may further comprise storing the detection result in a buffer over time as a plurality of iterations; outputting the detection result as a presence of the anomaly in response to the plurality of iterations having identified the anomaly at least a predetermined threshold number of times.

In some embodiments, the detection signal may be an acoustic signal detected at one or more channels of the sensor divided for the pipeline, and the sensor may be an optical sensor configured to capture at least one of temperature and strain measurements at the one or more channels of the sensor.

In some embodiments, the feature extraction model may be a one-dimensional convolutional neural network (1D CNN), and the method may further comprise formatting the detection signal into one-dimensional sequential data.

In some embodiments, the temporal processing model may be a bidirectional long short-term memory (BiLSTM) network, the plurality of states may be hidden states of the BiLSTM network, and the plurality of states may be concatenated outputs of a forward BiLSTM layer and a backward BiLSTM layer of the BiLSTM network.

In some embodiments, the feature extraction model may further divide the detection signal into a plurality of windows using a sliding-time window technique, each window comprising a segment of the detection signal spanning a specific length of time defined by the plurality of temporal stamps, and wherein a 1D CNN may be applied to each of the plurality of windows on a per-window basis to extract the feature map.

According to another aspect of the disclosure, there is provided a method comprising: providing a training dataset of a detection signal from a sensor deployed along a pipeline to an artificial neural network, the training dataset comprising training signals representative of anomalies and non-anomalies in respect of the pipeline, wherein the artificial neural network comprises a feature extraction model that extracts from the detection signal a feature map that represents one or more patterns along a temporal dimension represented by a plurality of temporal stamps; a temporal processing model that generates from the feature map a plurality of states that capture temporal dependencies, wherein each of the plurality of states corresponds to one of the plurality of temporal stamps, and wherein the temporal dependencies represent an influence on one of the plurality of states by at least one other of the plurality of states; and a weighting model that assigns a weight to each of the plurality of states to generate weighted representations of the plurality of states using an attention mechanism; and training, by using the training dataset, the artificial neural network to generate a detection result from the plurality of states using the training dataset.

In some embodiments, the detection result may be either leak or non-leak, and data in the training dataset labeled with the non-anomaly may comprise a first set of data labeled with a non-leak activity and a second set of data labeled with noise.

In some embodiments, the weighting model may comprise a plurality of attention heads, each head configured to: calculate one or more attention scores for each of the plurality of states; normalize the one or more attention scores using a softmax function; generate one or more weights from the normalized one or more attention scores; and generate weighted representations of the plurality of states using the one or more weights.

In some embodiments, the weighted representations from each of the plurality of attention heads may be combined to form an aggregated representation, the aggregated representation being used to update the plurality of states.

In some embodiments, the weighted representations may be averaged using a mean function, and an output of the mean function may be passed through a linear layer that applies a linear transformation prior to obtaining the detection result.

In some embodiments, the detection signal may be an acoustic signal detected at one or more channels of the sensor divided for the pipeline, and the sensor may be an optical sensor configured to capture at least one of temperature and strain measurements at the one or more channels of the sensor.

In some embodiments, the feature extraction model may be a one-dimensional convolutional neural network (1D CNN), and the detection signal may be formatted into one-dimensional sequential data.

In some embodiments, the temporal processing model may be a bidirectional long short-term memory (BiLSTM) network, the plurality of states may be hidden states of the BiLSTM network, and the plurality of states may be concatenated outputs of a forward BiLSTM layer and a backward BiLSTM layer of the BiLSTM network.

In some embodiments, the feature extraction model may further divide the detection signal into a plurality of windows using a sliding-time window technique, each window comprising a segment of the detection signal spanning a specific length of time defined by the plurality of temporal stamps, and wherein a 1D CNN may be applied to each of the plurality of windows on a per-window basis to extract the feature map.

According to another aspect of the disclosure, there is provided a system for detecting anomalies in a pipeline, comprising a sensor deployed along the pipeline, configured to generate and transmit a detection signal; an artificial neural network configured to receive the detection signal, the artificial neural network comprising a feature extraction model that extracts from the detection signal a feature map that represents one or more patterns along a temporal dimension represented by a plurality of temporal stamps; a temporal processing model that generates from the feature map a plurality of states that capture temporal dependencies, wherein each of the plurality of states corresponds to one of the plurality of temporal stamps, and wherein the temporal dependencies represent an influence on one of the plurality of states by at least another of the plurality of states; and a weighting model that assigns a weight to each of the plurality of states to generate weighted representations of the plurality of states using an attention mechanism, wherein the artificial neural network is trained prior to receiving the detection signal to generate a detection result from the plurality of states using a training dataset comprising training signals representative of anomalies and non-anomalies in respect of the pipeline, and wherein a set of data from the training signals is labeled with a leak; and an output module configured to obtain the detection result from the artificial neural network.

According to another aspect of the disclosure, there is provided a non-transitory computer-readable medium having instructions stored thereon, the instructions configured when read by a computer to cause the computer to perform a method comprising: receiving a detection signal from a sensor deployed along a pipeline; inputting the detection signal to an artificial neural network comprising a feature extraction model that extracts from the detection signal a feature map that represents one or more patterns along a temporal dimension represented by a plurality of temporal stamps; a temporal processing model that generates from the feature map a plurality of states that capture temporal dependencies, wherein each of the plurality of states corresponds to one of the plurality of temporal stamps, and wherein the temporal dependencies represent an influence on one of the plurality of states by at least another of the plurality of states; and a weighting model that assigns a weight to each of the plurality of states to generate weighted representations of the plurality of states using an attention mechanism; and obtaining a detection result from the artificial neural network, wherein prior to receiving the detection signal, the artificial neural network has been trained to generate the detection result from the plurality of states using a training dataset comprising training signals representative of anomalies and non-anomalies in respect of the pipeline, and wherein a set of data from the training signals is labeled with a leak.

This summary does not necessarily describe the full scope of all aspects. Other aspects, features and advantages will become apparent to those of ordinary skill in the art upon review of the following description of specific embodiments.

### BRIEF DESCRIPTION OF THE DRAWINGS

In the accompanying drawings, which illustrate one or more example embodiments:

FIG. 1A is a block diagram of a system for fiber optic sensing using backscattering occurring in an optical fiber, according to an embodiment.

FIG. 1B is a schematic that depicts how fiber Bragg gratings (“FBGs”) reflect a light pulse, according to an embodiment.

FIG. 1C is a schematic that depicts how a light pulse interacts with impurities in an optical fiber that results in scattered laser light due to Rayleigh scattering, which is used for distributed acoustic sensing (“DAS”), according to an embodiment.

FIG. 2 is an overall process for detecting anomalies in a pipeline using an artificial neural network, according to an embodiment.

FIG. 3 is an integrated model for leak detection, according to an embodiment.

FIG. 4 is a data spectrum, indicating all features collected from a segment of a pipeline over time, according to an embodiment.

FIG. 5 is a data spectrum, indicating a feature collected from a segment of a pipeline over time, according to an embodiment.

FIG. 6 is a graph showing training accuracy over 30 epochs, where the Y-axis represents accuracy and the X-axis represents epochs, according to an embodiment.

FIG. 7 is a graph showing the root mean square of the magnitude across the timeline in a first simulation, according to an embodiment.

FIG. 8 is a graph showing the root mean square of the magnitude across the timeline in a second simulation, according to an embodiment.

FIG. 9 is a false positive heatmap in different areas of pipelines over time for a first site activity dataset, according to an embodiment.

FIG. 10 is a false positive heatmap in different areas of pipelines over time for a second site activity dataset, according to an embodiment.

FIG. 11 shows updated counts of false positives with post-processing applied in the first dataset, according to an embodiment.

### DETAILED DESCRIPTION

Embodiments herein utilize detectors deployed along a pipeline to obtain measurements at various locations of the pipeline, such that fluid flow conditions within the pipeline can be monitored in real time. These detectors not only enhance the safety and efficiency of pipeline operations, but also provide operators with actionable insights to prevent potential pipeline problems and ensure optimal fluid transportation.

One type of detector is a variety of meters placed in or on a pipeline to monitor changes in parameters such as temperature, pressure, and flow. These meters may be an integral part of Computational Pipeline Monitoring (CPM) systems, which convert real-time measurements into valuable data that can be used to detect anomalies or inefficiencies in pipeline operations. CPM uses the data obtained from these types of detectors to provide a comprehensive view of pipeline health, ensuring that any deviations from standard operating parameters are promptly addressed.

Another type of detector is an optical fiber (also referred to as a fiber optic sensor) placed along a pipeline to measure changes in temperature and strain, for example, with high spatial resolution. This optical sensing approach can take advantage of three types of scattering: Rayleigh, Brillouin and Raman. While Rayleigh scattering results from variations in the fiber's refractive index, Brillouin scattering is induced by acoustic waves generated by light-fiber interactions and provides insight into temperature and strain changes. Raman scattering, resulting from the interaction of light with the fiber's vibrational modes, provides nuanced data on chemical composition, temperature and strain. Fiber Bragg gratings (FBGs) may enhance this technique by reflecting Raman-scattered light for high-resolution detection. However, the inherent properties of Raman scattering itself do not require reflectors. Distributed Acoustic Sensing (DAS) is a technology that leverages the entire length of the optical fiber as a sensor. It enables the continuous monitoring of acoustic vibrations along the pipeline, making it possible to detect events such as leaks, turbulences, intrusions, or equipment malfunctions. In the context, the term “intrusion” refers to a third party interference event such as an unauthorized product withdrawal. DAS works by analyzing the backscattered light from the fiber caused by strain-induced changes, allowing for real-time, multi-dimensional monitoring of the pipeline's conditions. By combining optical fibers with traditional meter-based detectors and incorporating FBG, DAS, Raman scattering techniques, etc., operators can deploy a comprehensive multi-dimensional monitoring approach. This approach ensures maximum reliability and accuracy in capturing various aspects of pipeline conditions.

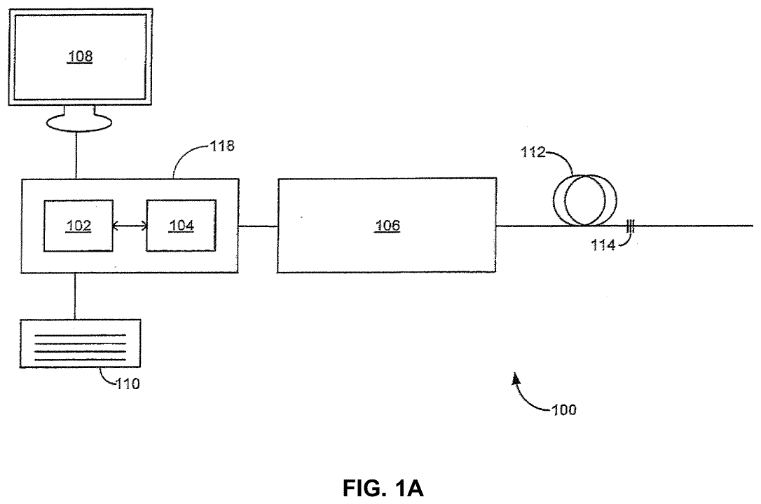

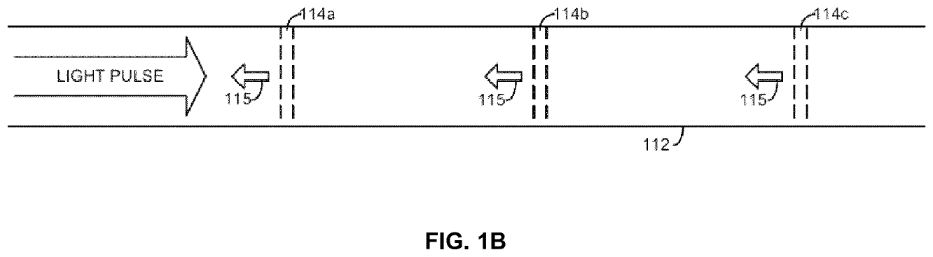

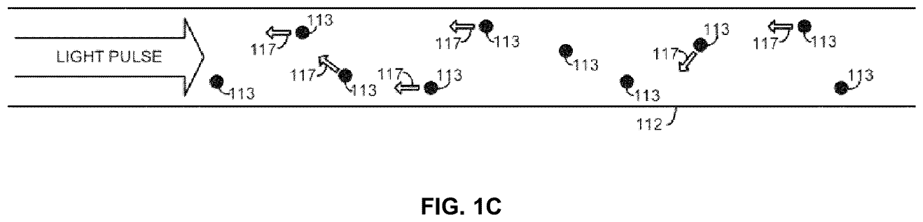

Referring now to FIG. 1A, an embodiment of a system 100 for fiber optic sensing using backscattering occurring in an optical fiber is shown. This embodiment illustrates a working environment for simultaneously measuring temperature and strain using Raman scattering, as described herein. The system 100 comprises an optical fiber 112, an interrogator 106 optically coupled to the optical fiber 112, and a signal processing device (controller) 118 in communication with the interrogator 106. Although not shown in FIG. 1A, the interrogator 106 includes an optical source, an optical receiver, and an optical circulator. The optical circulator directs light pulses from the optical source to the optical fiber 112 and directs light pulses received by the interrogator 106 from the optical fiber 112 to the optical receiver.

The optical fiber 112 comprises one or more fiber optic strands, each of which is made of silica (amorphous SiO₂). The optical fiber strands are doped with a rare earth compound (such as germanium, praseodymium, or erbium oxides) to alter their refractive indices, although in alternative embodiments the optical fiber strands may be un-doped. Single mode and multimode optical fiber strands are commercially available from, for example, Corning® Optical Fiber. Examples of optical fibers include ClearCurve™ fibers (bend insensitive), SMF28 series single mode fibers such as SMF-28 ULL fibers or SMF-28e fibers, and InfiniCor® series multimode fibers.

The interrogator 106 generates sense and reference pulses and outputs the reference pulse after the sense pulse. The pulses are transmitted along the optical fiber 112, which includes an FBG 114. The FBG 114 acts as a reflector as discussed above, but it should be understood that the reflector, such as the FBG 114 shown in FIG. 1A, is not necessary for Raman scattering to occur, and the system 100 can function without the FBG 114.

In this embodiment, the interrogator 106 emits laser light toward the optical fiber 112, and the FBG 114 partially reflects the light back toward the interrogator 106. An optical receiver (not shown) detects the backscattered light and generates an output signal. The signal processing device (controller) 118 is communicatively coupled to the interrogator 106 to receive the output signal. The signal processing device 118 includes a processor 102 and a non-transitory computer readable medium 104 communicatively coupled to each other. An input device 110 and a display 108 interact with the processor 102. The computer readable medium 104 has statements and instructions encoded thereon to cause the processor 102 to perform any appropriate signal processing methods on the output signal. For example, if the fiber segment 116 is laid adjacent to a region of interest that simultaneously experiences vibration at a rate below 20 Hz and acoustics at a rate above 20 Hz, the fiber segment 116 will experience similar strain and the output signal will comprise a superposition of signals representative of that vibration and those acoustics. To isolate the vibration portion of the output signal from the acoustics portion of the output signal, the processor 102 may apply a low pass filter with a cutoff frequency of 20 Hz to the output signal. Similarly, the processor 102 may apply a high pass filter with a cutoff frequency of 20 Hz to isolate the acoustic portion of the output signal from the vibration portion. The processor 102 may also apply more complex signal processing methods to the output signal; example methods include those described in PCT application PCT/CA2012/000018 (publication number WO 2013/102252), the entirety of which is hereby incorporated by reference.

Although FIG. 1A illustrates an embodiment where measurements are obtained using fiber optics, it should be understood that other types of sensors deployed along the pipeline can also be used to detect various conditions and obtain measurements for leak detection. These sensors may include, but are not limited to, acoustic sensors, pressure sensors, temperature sensors, and vibration sensors. The data acquired from these alternative sensors can be similarly processed and analyzed using the embodiments described herein, which will be further detailed in the following, to enhance the detection of anomalies and leaks within the pipeline.

FIG. 1B depicts how the FBGs 114 reflect the light pulse, according to another embodiment in which the optical fiber 112 comprises a third FBG 114c. In FIG. 1B, the second FBG 114b is equidistant from each of the first and third FBGs 114a,c when the fiber 112 is not strained. The light pulse is propagating along the fiber 112 and encounters three different FBGs 114, with each of the FBGs 114 reflecting a portion 115 of the pulse back towards the interrogator 106. In embodiments comprising three or more FBGs 114, the portions of the sensing and reference pulses not reflected by the first and second FBGs 114a,b can reflect off the third FBG 114c and any subsequent FBGs 114, resulting in interferometry that can be used to detect an acoustic vibration along the fiber 112 occurring further from the optical source 101 than the second FBG 114b. For example, in the embodiment of FIG. 1B, a portion of the sensing pulse not reflected by the first and second FBGs 114a,b can reflect off the third FBG 114c and a portion of the reference pulse not reflected by the first FBG 114a can reflect off the second FBG 114b, and these reflected pulses can interfere with each other at the interrogator 106.

Any changes to the optical path length of the fiber segment 116 result in a corresponding phase difference between the reflected reference and sensing pulses at the interrogator 106. Since the two reflected pulses are received as one combined interference pulse, the phase difference between them is embedded in the combined signal. This phase information can be extracted using proper signal processing techniques, such as phase demodulation. The relationship between the optical path of the fiber segment 116 and that phase difference (θ) is as follows: θ=2πL/λ, where n is the index of refraction of the optical fiber; L is the optical path length of the fiber segment 116; and λ is the wavelength of the optical pulses. A change in nL is caused by the fiber experiencing longitudinal strain induced by energy being transferred into the fiber. The source of this energy may be, for example, an object outside of the fiber experiencing dynamic strain, undergoing vibration, emitting energy or a thermal event.

One conventional way of determining ΔnL is by using what is broadly referred to as distributed acoustic sensing (“DAS”). DAS involves laying the fiber 112 through or near a region of interest (e.g. a pipeline) and then sending a coherent laser pulse along the fiber 112. As shown in FIG. 1C, the laser pulse interacts with impurities 113 in the fiber 112, which results in scattered laser light 117 because of Rayleigh scattering. Vibration or acoustics emanating from the region of interest results in a certain length of the fiber becoming strained, and the optical path change along that length varies directly with the magnitude of that strain. Some of the scattered laser light 117 is back scattered along the fiber 112 and is directed towards the optical receiver 103, and depending on the amount of time required for the scattered light 117 to reach the receiver and the phase of the scattered light 117 as determined at the receiver, the location and magnitude of the vibration or acoustics can be estimated with respect to time. DAS relies on interferometry using the reflected light to estimate the strain the fiber experiences. The amount of light that is reflected is relatively low because it is a subset of the scattered light 117. Consequently, and as evidenced by comparing FIGS. 1B and 1C, Rayleigh scattering transmits less light back towards the optical receiver 103 than using the FBGs 114.

DAS accordingly uses Rayleigh scattering to estimate the magnitude, with respect to time, of the acoustic vibration experienced by the fiber during an interrogation time window, which is a proxy for the magnitude of the acoustic vibration. In contrast, the embodiments described herein measure acoustic vibrations experienced by the fiber 112 using interferometry resulting from laser light reflected by FBGs 114 that are added to the fiber 112 and that are designed to reflect significantly more of the light than is reflected as a result of Rayleigh scattering. This contrasts with an alternative use of FBGs 114 in which the center wavelengths of the FBGs 114 are monitored to detect any changes that may result to it in response to strain. In the depicted embodiments, groups of the FBGs 114 are located along the fiber 112. A typical FBG can have a reflectivity rating of 2% or 5%. The use of FBG-based interferometry to measure interference causing events offers several advantages over DAS, in terms of optical performance.

Conventionally, pipeline leak and anomaly detection involves various methodologies, primarily categorized into hardware-based and software-based approaches. Hardware-based methods rely on external systems and physical devices such as acoustic sensors, pressure sensors, vibration sensors, mobile wireless sensors, fiber optic sensors, infrared cameras, radar-based sensors, and electrokinetic methods to monitor pipeline conditions. Despite the wide range of sensor technologies available, maintaining an extensive sensor infrastructure is challenging and often impractical over long distances.

Software-based methods, on the other hand, focus on internal systems and algorithms that process data collected by hardware sensors to detect and pinpoint the exact location of leaks. Machine learning algorithms are used for these methods, providing continuous monitoring solutions by analyzing sensor data and distinguishing between normal variations and potential leaks. These algorithms increase the reliability of leak detection systems by identifying patterns associated with leaks.

Various machine learning models have been applied to pipeline leak detection, using both local and global dependencies to find patterns in the data. For example, deep learning models such as convolutional neural networks (CNNs) and long short-term memory (LSTM) networks have been used to capture spatial and temporal information, respectively. Despite their accuracy, these models often struggle to distinguish leaks from other anomalies, such as ancillary activity near pipelines, resulting in false alarms.

False alarms pose a significant challenge because they can disrupt normal operations, leading to unnecessary shutdowns or interventions. Given these limitations, the present disclosure presents advanced methods and systems that can accurately detect pipeline leaks while minimizing false alarms. For example, such methods and systems are able to capture both local and long-term dependencies in the data, assign appropriate weights to different parts of the input sequence, and refine the detection results to ensure reliability and accuracy.

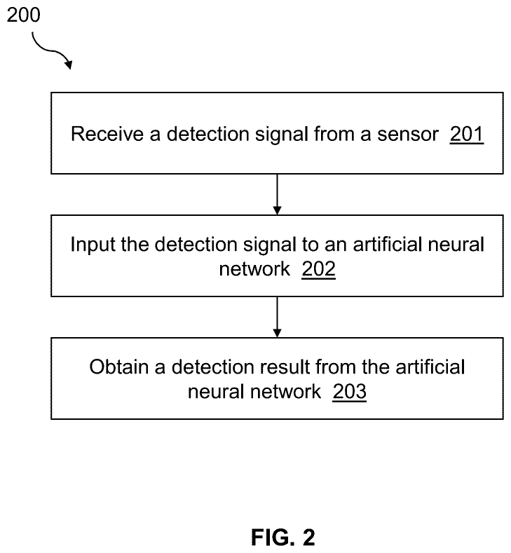

Referring now to FIG. 2, an overall process 200 for detecting anomalies in a pipeline using an artificial neural network is shown. The process 200 begins with operation 201 in which a detection signal is received from a sensor disposed along a pipeline. The sensor may be of any suitable type, such as an acoustic sensor, a pressure sensor, a temperature sensor, or a vibration sensor, designed to monitor various conditions within the pipeline. For example, an optical sensor may be deployed along the pipeline and divided into multiple channels along the length of the pipeline, each channel expanding the monitoring capabilities over a specific segment of the pipeline. For example, when multiple FBGs are used (such as shown in FIG. 1B), each channel can correspond to a length of optical fiber between a pair of successive FBGs. These sensors collect real-time data regarding the operational status and environmental conditions surrounding the pipeline for identifying potential anomalies.

In operation 202, the detection signal is fed into an artificial neural network (ANN). The ANN may comprise multiple models that work together to analyze the signal. First, a feature extraction model processes the detection signal to extract a feature map representing one or more patterns along a temporal dimension. The temporal dimension is represented by a plurality of temporal stamps that provide a time series representation of the detected patterns. The temporal stamps characterize the detection signal in a continuous flow of data into discrete segments that can be represented, for example, by a matrix. This matrix representation allows the ANN to efficiently process and analyze the data, highlighting patterns and features that may indicate the presence of anomalies. By transforming the raw detection signal into a structured feature map, the feature extraction model is used as the initial stage of data processing within the ANN.

A feature map, in the context of an ANN, refers to a structured representation of the detection signal, highlighting patterns and features within the data. This map captures essential characteristics of the signal, such as variations and trends over time, for identifying anomalies. Feature maps can be represented in various forms, depending on the nature of the data and the design of the ANN, such as in a one-dimensional matrix or a multi-dimensional matrix form. This matrix form allows the ANN to perform convolutional operations across the temporal dimension, effectively identifying local patterns and dependencies within the data.

Following feature extraction, a temporal processing model within the ANN generates a set of states from the feature map. Each state corresponds to one of the temporal stamps and captures temporal dependencies. These dependencies represent the influence of one state on another over time, providing insight into the sequential and dynamic nature of the data. In other words, this temporal processing generates multiple states, each carrying information from other states, indicating how certain patterns evolve and interact over time.

The ANN may further incorporate a weighting model that assigns a weight to each of the multiple states using an attention mechanism. This mechanism may calculate one or more attention scores for each state, normalize these scores using a softmax function, for example, and generate weights from the normalized scores. The resulting weighted representations of states allow the ANN to focus on more relevant temporal dependencies, improving its ability to accurately detect anomalies. The attention mechanism ensures that the model gives more weight to specific time stamps that are more useful (non-noise) for identifying relevant patterns in the data set.

In operation 203, the ANN produces a detection result based on the processed signal. This result indicates the presence or absence of an anomaly in the pipeline. More particularly, the detection result may be either leak or non-leak. The ANN is pre-trained using a comprehensive dataset that includes signals representative of both anomalies and non-anomalies. This training process allows the ANN to learn the distinguishing features of each class, thereby improving its accuracy and reliability in real-world applications.

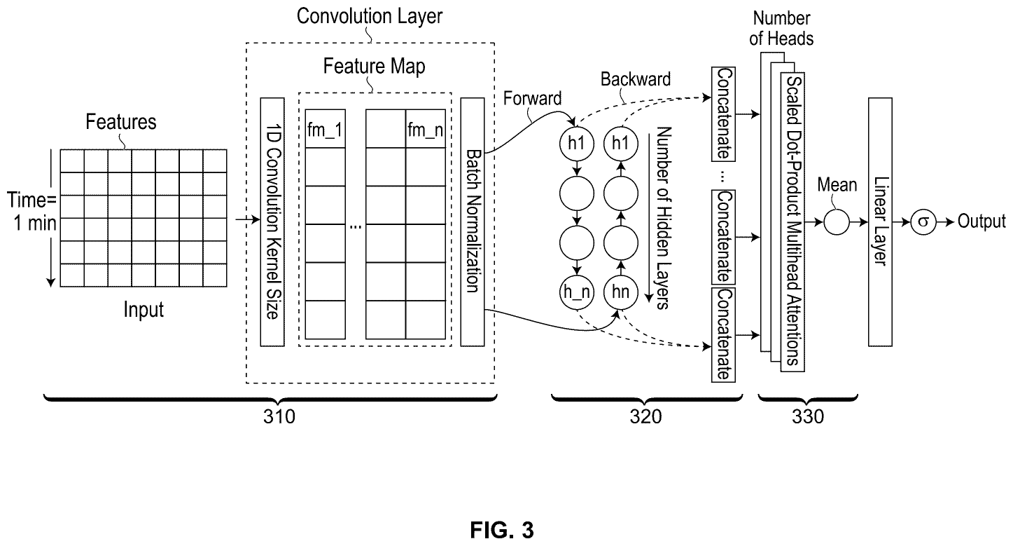

FIG. 3 illustrates an integrated model for leak detection, referred to as Contextual Bottleneck Attention Network (CB-AttentionNet), according to an example embodiment described herein. To capture both short-term and long-term dependencies within leak detection datasets, this model leverages a combination of one-dimensional convolutional neural networks (1D CNN) and bidirectional long short-term memory networks (BiLSTM). An attention mechanism is also incorporated for optimizing the model for leak detection.

In this embodiment, the CB-AttentionNet model is configured to process detection signals from a sensor deployed along a pipeline. The model is structured into three distinct components:
1D CNN: This component acts as the feature extractor. It processes the detection signal to extract a feature map that represents one or more patterns along a temporal dimension. The temporal dimension is represented by a plurality of temporal stamps, providing a time-series representation of the detected patterns. The feature map highlights spatial patterns and anomalies in the sensor data for detecting potential leaks.
BiLSTM Network: Following feature extraction, the BiLSTM network processes the feature map to generate a plurality of hidden states. Each hidden state corresponds to one of the temporal stamps and captures temporal dependencies, representing the influence of one state on another over time. The BiLSTM network is sensitive to dynamic changes, as it processes data in both forward and backward directions, thus capturing comprehensive temporal information.
Attention Mechanism: The attention mechanism further refines the model's focus by assessing the importance of various temporal and spatial segments selectively. It assigns weights to each of the hidden states, generating weighted representations that highlight more relevant parts of the input sequence. This selective focus is for accurately monitoring and detecting leaks.

### Feature Extraction Using 1D CNN

Stage 310 of FIG. 3 refers to the feature extraction stage of the CB-AttentionNet model, which utilizes a one-dimensional convolutional neural network (1D CNN) as the feature extraction model to process detection signals from the deployed sensor. The purpose of this stage is to convert raw detection signals into structured data that can be analyzed for anomaly detection.

The detection signal, represented as input data, is organized into a matrix where each row corresponds to a specific time interval (e.g., one minute), and each column represents different features extracted from the detection signal. The feature extraction model processes this input to identify and emphasize local patterns within the sequence. Local patterns refer to specific and often short-range features or anomalies within the data that can indicate changes or irregularities in the pipeline's operation. These patterns may include sudden spikes or drops in pressure, temperature fluctuations, or unusual acoustic signals that can signify a potential leak or other types of anomalies.

The 1D CNN operates by applying convolutional operations across the temporal dimension of the input matrix. Unlike traditional CNNs used for image processing, which accept two-dimensional images with multiple color channels, the 1D CNN is tailored for one-dimensional sequential data such as time series or structured tabular data. For example, the detection signal from the fiber optics may be formatted into one-dimensional sequential data prior to being input to the feature extraction model. This adaptation allows the network to detect local patterns within these sequences effectively.

The convolutional layer within the 1D CNN uses small filters or kernels that slide over the input sequence. Each kernel performs element-wise multiplications across the sequence of timestamps t to identify local patterns. The mathematical operation for this convolution is given by:

$${Y}_{t} = f ( {\sum }_{k = o}^{K - 1} {W}_{k} \cdot {X}_{t + k} + b ) \qquad ( 1 )$$

where Yₜ is the output for the sequence of timestamps t; ƒ( ) is the activation function; Wₖ is the weight at kernel position k; Xₜ₊ₖ is the kth feature in the window of features centered at position t; and b is the bias term.

In this context, a “window” refers to a segment of the input data that spans a specific length of time, defined by the number of temporal stamps. Temporal stamps are discrete time points that represent the detection signal at regular intervals. For example, if the detection signal is sampled once per minute, each temporal stamp corresponds to a one-minute interval. This creates a 1D representation of the data, where the sequence of temporal stamps captures the evolution of the signal over time.

The output Yₜ is repeated across all input sequences, producing a series of feature maps that represent patterns extracted from the input data. These feature maps provide high-level representations of the patterns within the detection signal, capturing the essential characteristics needed for further analysis.

Batch normalization may be applied to the feature maps to stabilize and accelerate the training process. This step ensures that the data maintains a consistent distribution, which helps in the efficient training of the model.

The feature maps generated in stage 310 are used as input for the second part of the CB-AttentionNet model, stage 320, which processes hierarchical dependencies using the BiLSTM layer as the temporal processing model. By extracting and normalizing features from the detection signal, the 1D CNN transforms raw detection signals into meaningful feature maps, providing a foundation for accurate and reliable anomaly detection in pipelines.

While the 1D CNN is used in this embodiment for feature extraction, it will be recognized that other algorithms can also be employed to extract features from raw signals or data. Alternative algorithms such as LSTM networks, Recurrent Neural Networks (RNNs), Autoencoders, and Wavelet Transforms may be used to process sequential data and identify relevant patterns. Additionally, expert-defined features may be incorporated to enhance the accuracy of the model by utilizing domain-specific knowledge to select relevant features. Principal Component Analysis (PCA) may also be employed as a dimensionality reduction technique, reducing the complexity of the input data while retaining critical information. Although the CB-AttentionNet model's effectiveness has been demonstrated using a 1D CNN, these other algorithms can also detect local and temporal patterns within time-series data. The feature extraction component of the CB-AttentionNet model is not limited to 1D CNNs but can include any suitable method for transforming raw detection signals into structured feature maps for analysis.

### Temporal Processing Using BiLSTM

The second part of the CB-AttentionNet model, illustrated as stage 320 in FIG. 3, focuses on temporal processing using the BiLSTM network. This stage may capture hierarchical dependencies within the feature maps generated in the previous stage, allowing for a comprehensive analysis of both short-term and long-term dependencies in the data.

A BiLSTM is a specialized variant of the recurrent neural network (RNN) known for its bidirectional nature. It processes the input sequence in both forward and backward directions, effectively capturing information from past and future contexts within sequential data. This bidirectional processing may be used for understanding the sequential data comprehensively, as it allows the model to capture relative information from both earlier and later states, thus enhancing its ability to analyze the data.

The BiLSTM architecture includes LSTM units, each comprising memory cells, input gates, forget gates, and output gates. These components work together to handle long-distance dependencies and address challenges such as vanishing or exploding gradients. The LSTM units operate by sequentially updating their internal states, considering the current input and the previous hidden state.

In the CB-AttentionNet model, the feature maps generated by the 1D CNN may be input into the BiLSTM layer. This layer may have two LSTM networks: one processes the input sequence in the forward direction, and the other processes it in the backward direction. The BiLSTM thus captures temporal dependencies by getting data from both forward and backward passes.

Mathematically, hₜ represents the hidden states at timestamps t and xₜ represents previous feature maps. The BiLSTM operation combines both forward and backward hidden states. The formula for the hidden state hₜ at timestamps t is given by:

$$BiLSTM : ( {\overleftarrow{h}}_{t} , {\vec{h}}_{t} ) = LSTM ( {x}_{t} , {\overleftarrow{h}}_{t - 1} , {\vec{h}}_{t + 1} ) \qquad ( 2 )$$

The final output hₜ is the concatenation of both backward and forward operations:

$${h}_{t} = [ {\overleftarrow{h}}_{t} ; {\vec{h}}_{t} ] \qquad ( 3 )$$

Each hidden state hₜ is calculated by the LSTM unit using the following operations for the forget gate ƒₜ, input cell gₜ, and output cell oₜ:

$${c}_{t} = {f}_{t} ⊙ {c}_{t - 1} + {i}_{t} ⊙ {g}_{t} , {h}_{t} = {o}_{t} ⊙ tanh ( {c}_{t} ) \qquad ( 4 )$$

where it controls the flow of new information into the cell state by applying a sigmoid activation to the weighted sum of the input, previous hidden state, and bias vector; the forget gate ƒₜ modulates what information to discard from the cell state based on the input, previous hidden state, and bias vector through a sigmoid activation; the cell input gₜ integrates new information into the cell state using the hyperbolic tangent function; and the cell state cₜ is updated by a combination of the forget gate's action on the previous cell state and the input gate's effect on the cell input.

In this example, the network structure for the RNN module may follow a BiLSTM layer and dropout layers on feature maps. The dropout layers may randomly set a fraction of the output units to zero during training, which helps to prevent the network from becoming too dependent on specific neurons and improves its ability to generalize to new data. In the sequential dataset, understanding both short-term patterns and long-term dependencies leads to accurate analysis and prediction. Comprehensive monitoring of leaks across different temporal scales can be achieved by integrating both short and long dependencies, which ensures a more effective and reliable detection mechanism.

The ability of the BiLSTM to capture comprehensive temporal dependencies makes it an integral component of the CB-AttentionNet framework. The output from the BiLSTM layer, consisting of concatenated forward and backward hidden states, provides a rich representation of the sequential data. This output captures both short-term patterns and long-term dependencies for accurate analysis and prediction of anomalies in pipeline monitoring.

While the BiLSTM network is used in this embodiment for temporal processing, it will be recognized that other models may also be employed to capture temporal dependencies within sequential data. Alternative models such as standard LSTM networks, Gated Recurrent Units (GRUs), Transformer models, and Temporal Convolutional Networks (TCNs) can also be used to analyze the temporal relationships in the data. Although the CB-AttentionNet model's effectiveness has been demonstrated using a BiLSTM, these other models can similarly capture both short-term and long-term dependencies. The choice of model may depend on specific application requirements, computational efficiency, and the nature of the input data. Thus, the temporal processing component of the CB-AttentionNet model is not limited to BiLSTM networks but can include any suitable method for understanding and analyzing temporal dependencies within the feature maps.

### Attention Mechanism

The third part of the CB-AttentionNet model, illustrated as stage 330 in FIG. 3, incorporates an attention mechanism, such as a multi-head attention, to further refine the analysis of the detection signal. While the combination of 1D CNN and BiLSTM layers is effective at capturing local patterns and long-term dependencies, it may not always capture the most relevant information from the entire sequence. The attention mechanism addresses this limitation by selectively focusing on important parts of the input sequence.

The attention mechanism works by assigning different weights to the hidden states outputted by the BiLSTM layer. This approach emphasizes certain parts of the sequence, enhancing the model's ability to make accurate predictions. The process begins with the calculation of attention scores for each hidden state. Mathematically, if H represents the hidden states from the previous model, and Wₐ and Uₐ are weight matrices, the attention scores can be calculated as follows:

$$Attention ( H ) = softmax ( {W}_{a} tanh ( {U}_{a} {H}^{T} + {b}_{a} ) ) H \qquad ( 5 )$$

where Wₐ and Uₐ are the weight matrices; bₐ is the bias term; and softmax( ) is the activation function applied to normalize the attention scores.

The softmax function is applied to obtain attention weights that indicate the importance of each hidden state. These weights are then used to compute the context vector by combining the hidden states with their respective attention weights. This process allows the model to focus more on relevant parts of the input sequence by assigning higher weights to hidden states that are more important for generating context at each time step.

Other than the softmax function, alternative normalization techniques may be used to obtain the attention weights. Examples of such techniques include layer normalization, batch normalization, or other custom scaling approaches. Additionally, other functions such as sparsemax or sigmoid activation may be used as well, providing alternative methods to compute attention weights depending on the specific needs of the model.

The CB-AttentionNet model employs multiple attention mechanisms in parallel, known as multi-head attention, where multiple attention heads are used to capture different types of relationships in the data. Each head processes the input data differently, and their outputs are combined to form a richer representation. For example, the structure may include four attention mechanisms, each with a separate attention head that produces a set of attention-weighted representations. Each attention head has a different learning weight matrix, allowing the model to capture various aspects of the data.

The process described above may be performed multiple times in parallel, generating different sets of attention-weighted representations (outputs). The attention-weighted representations from each attention head are then averaged using a mean function. This mean output is then passed through a linear layer, which applies a linear transformation to further refine the data. The final output is obtained after this linear transformation.

The incorporation of the attention mechanism into the CB-AttentionNet model ensures that the model can focus on the more relevant parts of the input sequence, enhancing its ability to detect anomalies accurately. By assigning different weights to different parts of the sequence, the attention mechanism helps the model to prioritize important information and reduce the influence of noise or less relevant data.

While the multi-head attention mechanism is used in this embodiment for weighting and refining the analysis of the detection signal, it will be recognized that other mechanisms may also be employed to achieve similar results. Alternative techniques such as context gating, residual connections, or feature aggregation methods can be used to enhance the model's ability to focus on relevant parts of the input sequence. Although the effectiveness of the CB-AttentionNet model has been demonstrated using the multi-head attention mechanism, these other techniques may also prioritize important information and reduce the influence of noise or less relevant data.

### Training

The training dataset for the CB-AttentionNet model ensures its accuracy and reliability in detecting pipeline leaks. The model is trained using a curated dataset of raw acoustic signals recorded over time from pipelines. These signals may encompass various features, representing different conditions and potential anomalies within the pipeline.

The training dataset includes raw acoustic signals that have been recorded over extended periods. This dataset may be intentionally balanced to ensure a representative distribution of samples, which differs from the generated signals. This balanced composition enhances the credibility and robustness of the model's results. To effectively process this data, a sliding-time window technique is applied. This technique may divide the dataset into multiple equal-length subsequences or windows denoted as W={w1, w2, . . . , wₙ}. Each individual sample within these windows is analyzed independently to determine whether there is a leak. Within each window w, there exists a sequence of variables at time t, {tᵢ, i=1, 2, . . . , n}, which aids in the identification of leaks. Breaking down the data into manageable subsequences reduces computational complexity and enhances real-time leak detection capabilities, allowing for efficient analysis and rapid detection of leaks.

If a leak occurs, the model may output a flag. However, various environmental factors around pipelines can trigger false alarms, resembling the patterns of leaks. When an irregular activity occurs that looks similar to a leak, it is desirable to determine if the activity is a leak or a false positive. The determination may consider the behavior of leaks, which typically have a predictable and consistent pattern over time. Therefore, the model's output may be stored in a buffer, and the following sequence of results, denoted as i₁, i₂, . . . , iₘ, is examined. If there is a leak in these m subsequent occurrences, the model raises a flag. If not, it indicates the possible presence of another abnormal activity.

In summary, the entire process of the anomaly detection method described herein can be represented by the following pseudocode:

| Input: Window of size w data, number of iterations i | |
|---|---|
| Output: Flag indicating if it is a leak | |
| Procedure: | |
| 1. | for each window do |
| 2. | feature_maps ← Apply 1D-CNN to window; |
| 3. | hidden_layers ← Apply BiLSTM on feature_maps; |
| 4. | foreach attention_head in heads do |
| 5. | Apply attention_head on hidden_layers; |
| 6. | mean_attention ← Compute mean from the attentions |
| 7. | for i ← 1 to i do |
| 8. | Apply iteration i and store result in buffer; |
| 9. | final_result ← Compute result based on the buffer; |
| 10. | if final_result meets criteria then |
| 11. | return Leak Detected; |
| 12. | else |
| 13. | return No Leak; |

### Experimental Results

A series of experiments were conducted to test the effectiveness and accuracy of the CB-AttentionNet model and the training methodology described herein in detecting pipeline leaks and other anomalies. These experiments were designed to evaluate the model's performance in real-world scenarios, ensuring its robustness and reliability.

As described above, fiber optics can serve as a continuous linear sensor for pipelines, installed along their length to detect various types of dynamic energy irregularities such as acoustics, strain, and temperature. For example, the fiber optics may include multiple FBGs along the length, such as shown in FIG. 1B. This setup allows the collection of real-time data on these variables over time. The dataset used for the experiment comprised industrial real-time series data, including simulated instances of leaks and other abnormal activities, providing valuable information for analyzing the model's performance in real-world scenarios.

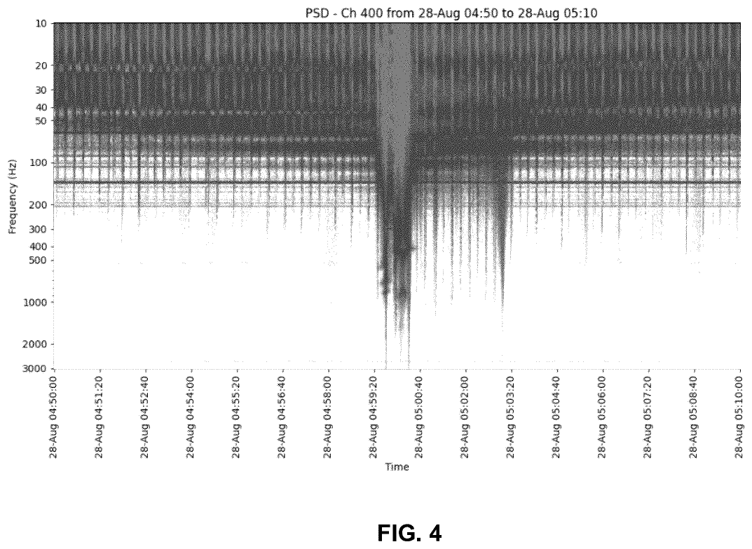

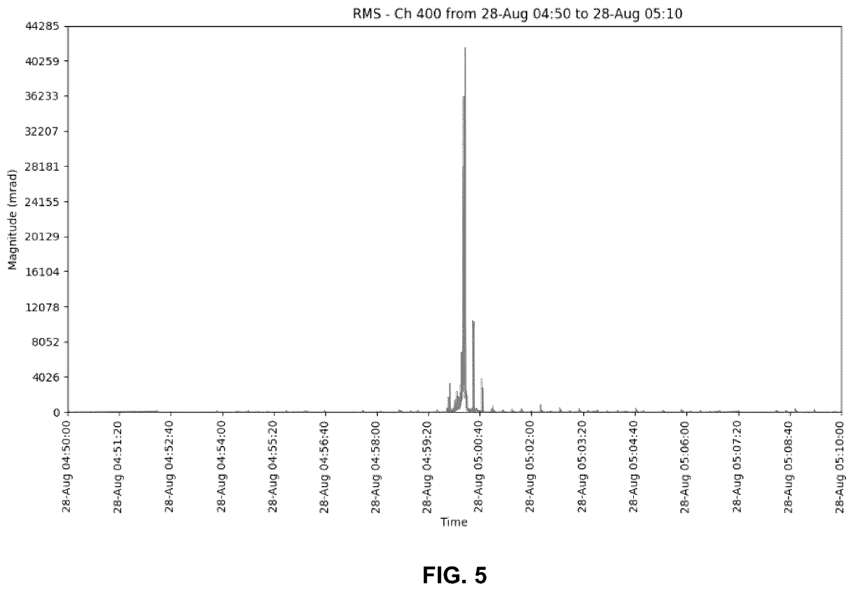

The dataset was structured in three dimensions: timestamps, features (such as temperature and strain represented by a frequency response), and pipeline regions (channels), as shown in FIG. 4. The dataset included entries corresponding to specific points in time and measured various features (in Hz) within the pipeline from different channels. These features displayed different patterns over time across pipeline areas, as shown in FIG. 4, suggesting that temperature, strain, and other attributes behaved differently depending on the segment. While FIG. 4 illustrates all the features for a segment (“Ch 400” in FIG. 4) of the pipeline over time (20 minutes in FIG. 4), FIG. 5 illustrates one of the features (in radians) for a segment (“Ch 400” in FIG. 4) of the pipeline over time (20 minutes in FIG. 4).

For training purposes, the model was trained on smaller subsequences to yield real-time outcomes. The training dataset utilized 80% of the total data, comprising a cumulative duration of over 20 hours from five different areas of pipelines. This dataset included non-leak signals, leaks, and other abnormal activities. Specifically, the dataset contained 550 samples, 50% of which represented leaks, while the remaining 50% included other abnormal activities such as site activities (15%) and non-leak signals. The remaining 20% of the dataset constituted the test data, used to evaluate the model's performance in terms of false positive rates, recall, precision, and F1 measure (a metric used to evaluate the accuracy of a model).

The dataset's structure, divided into timestamps, features, and channels, allowed for training and testing of the model. Each entry in the dataset corresponded to specific time points and measured various features within different segments of the pipeline. This segmentation helped in capturing the distinct patterns of temperature, strain, and other attributes over time, ensuring that the model can accurately detect leaks and other anomalies. The balanced composition of the dataset, with equal representation of leaks and other activities, enhanced the model's ability to distinguish between genuine leaks and false alarms caused by environmental factors or other irregular activities.

In evaluating the leak detection model, a set of metrics was employed to assess its performance across different scenarios. For the test dataset containing leaks, the focus was on precision, recall, F1 score, false negative rate, and accuracy. By measuring precision and recall, the model's capability to make accurate positive predictions and correctly identify actual positives was assessed. The F1 score provided a balanced measure considering both false positives and false negatives. The false negative rate specifically highlighted the proportion of actual leaks incorrectly identified as non-leaks.

The formulas used for these metrics are as follows:

$$Precision = \frac{TruePositives}{TruePositives + FalsePositives} \qquad ( 6 )$$

$$Recall = \frac{TruePositives}{TruePositives + FalseNegatives} \qquad ( 7 )$$

$$F 1 Score = 2 \times \frac{Precision \times Recall}{Precision + Recall} \qquad ( 8 )$$

$$FalsePositiveRate = \frac{FalsePositives}{ActualPositives} \qquad ( 9 )$$

Additionally, the model was evaluated using the test dataset featuring abnormal behaviors other than leaks. For this dataset, the focus was on the false positive rate. Comparing this rate with similar rates from baseline models enabled an understanding of how effectively the model differentiated between different types of abnormal behavior. This comprehensive evaluation ensured that the model not only accurately detected leaks but also minimized false positives and effectively distinguished between various abnormal events.

In dealing with acoustic signals or any data that exhibits varying levels of noise or intensity, the issue of disparate scales among features often arises. This discrepancy can influence machine learning models, as certain features with higher magnitudes may dominate the modeling process, leading to biased results. To address this challenge, normalization and scaling techniques were employed. Specifically, means and standard deviations for z-score normalization were separately calculated for each feature within each area using exclusively non-leak data. This procedure aimed to create a consistent scale for each feature in every area, ensuring fair comparisons by dividing each data point by its respective standard deviation. This standardized the data distributions to have a mean of 0 and a standard deviation of 1, enabling equitable analysis across different features and areas while reducing the influence of non-leak data variations.

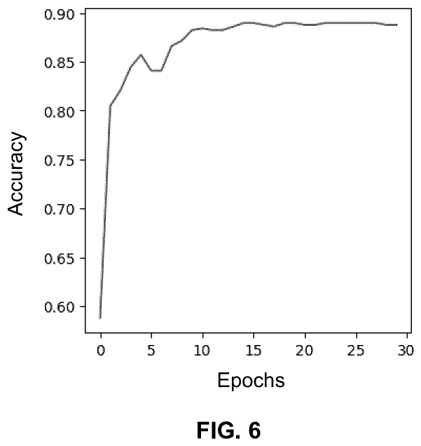

The model training process involved three distinct stages. Initially, the process began with a 1D-CNN utilizing convolution layers with a 3×3 kernel size to extract vertical feature maps from each variable. Following this, a BiLSTM configuration was implemented, comprising three layers with a hidden size of 64. Additionally, a dropout layer with a 0.2 probability was integrated to prevent overfitting. Subsequently, there were four attention heads, followed by additional dropout layers with a 0.2 probability. Then, the model additionally included two layers: a linear layer followed by a non-linear layer employing a sigmoid function. An Adam optimizer with a learning rate of 0.0002 was utilized, and the learning scheduler was parameterized with a step size of 7 and a gamma value of 0.1 to optimize the learning process and mitigate overfitting challenges. Both training and evaluation were conducted using PyTorch™ version 2.1.1 and CUDA™ 11.8. Training was performed on the dataset for 50 epochs, with early stopping implemented when the accuracy of the training data began to degrade. At the 30^{th} epoch, the model achieved an accuracy of 89.9%, coupled with a loss value of 0.313, as shown in FIG. 6. It should be understood that these parameters, including the number of epochs, accuracies, and other configurations, are merely one possible example, and different setups may result in variations in performance and outcomes.

In the model according to the embodiments described herein, outputs indicating potential leaks were captured and temporarily stored. Instead of immediately classifying these detections as leaks, the detection was verified by observing the system's behavior in subsequent iterations. The system was monitored for continued signs of the initially detected anomaly during these iterations. If the same pattern was consistently observed in these additional checks, it strengthened the evidence that the initial detection was indeed a leak, and the system flagged the initial output accordingly. This additional verification step is referred to as post-processing.

The results of the model were obtained after experiments based on the described process. The evaluation was based on two different scenarios. For all simulations, 5-fold cross-validation was conducted on each dataset, and the reported results represent the average performance across these folds.

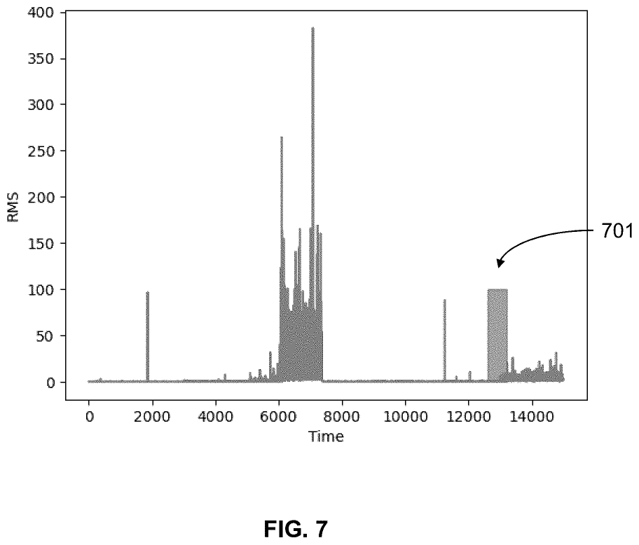

FIG. 7 shows the root mean square (RMS) of magnitude, represented in radians, across the time axis per millisecond in the first simulation of the first scenario, where leaks occurred in two specific pipelines on different dates over a period of time. The model examined signal data within one-minute intervals on windows. Among a total of 23 minutes observed and 10 minutes of leaks, all leaks were detected with an accuracy of 95.83%, precision of 99%, and recall of 89%. There was only one occurrence of false negatives. During that single minute window when a leak occurred (denoted as 701 in FIG. 7), the model detected the leak with a delay of less than a minute. Because the system maintained results in a buffer for three iterations, this delay did not affect its overall performance. An irregular spike or pulse corresponds to leaks, and a highlighted area 701 indicates a leak that was detected late. Non-highlighted areas represent correct predictions.

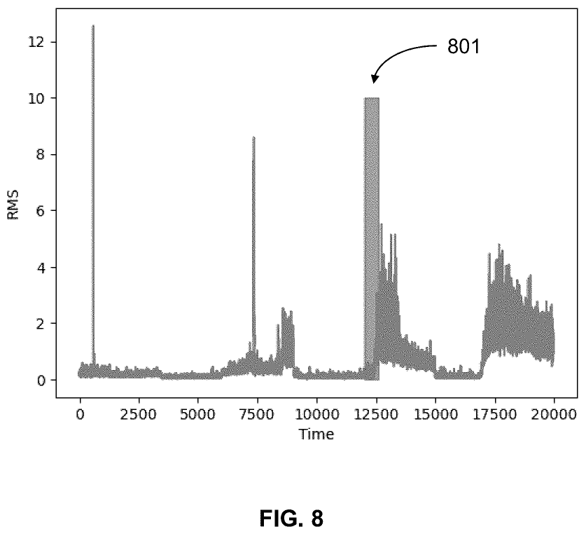

FIG. 8 shows the RMS of magnitude, represented in radians, across the time axis per millisecond in the second simulation within the first scenario, where a window size of one minute was tested on 24 minutes of observed signals with a total of 10 minutes of leaks. Accuracy, precision, and recall were 96%, 99%, and 93%, respectively. As before, highlighted areas (denoted by 801 in FIG. 8) indicate delayed leak detection. There were no false positives. An irregular spike or pulse corresponds to leaks, and a highlighted area 801 indicates a leak that was detected late. Non-highlighted areas represent correct predictions.

In the second scenario, the model's effectiveness was evaluated when confronted with different anomalies. Tests were conducted on two distinct site activities near pipelines to assess the occurrence of false positives. Each dataset represented approximately 2 hours of simulation.

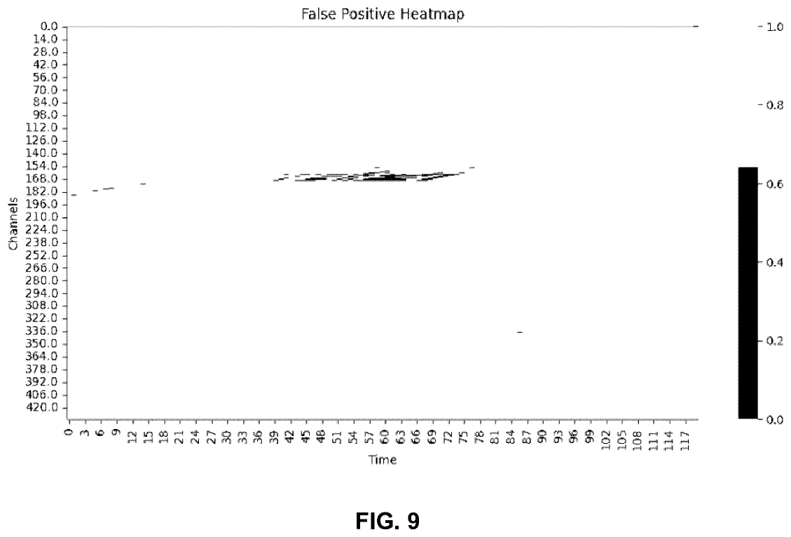

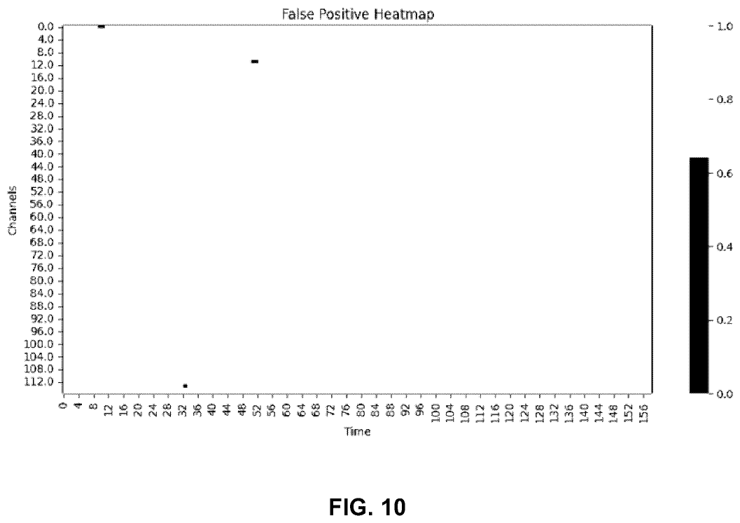

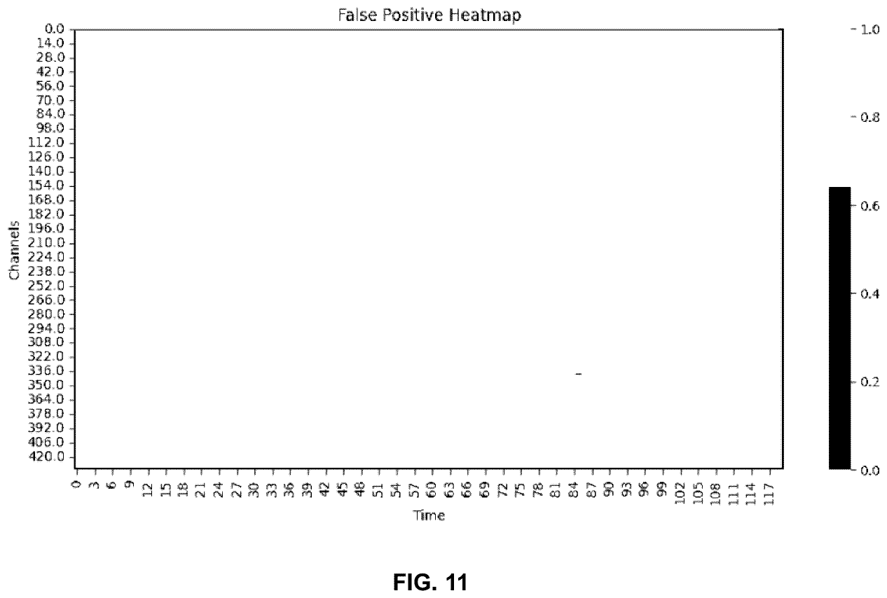

FIG. 9 shows a false positive heatmap in different areas of pipelines (known as channels) over time (one-minute intervals) for the first site activity dataset. This plot shows false positives detected in each area over time before post-processing, with a total of 200 false positives. FIG. 10 shows a false positive heatmap in different areas of pipelines (known as channels) over time (one-minute intervals) for the second site activity dataset. This plot shows false positives detected in each area over time before post-processing, with a total of 5 false positives. FIG. 11 illustrates the updated counts of false positives after post-processing was applied in the first dataset, showcasing the notable decrease in false alarms. The false positive heatmap for different areas of pipelines over time for the first site activity dataset after post-processing shows the total number of false positives reduced to 3.

Following the application of post-processing techniques, the number of false alarms was significantly reduced. The number of false alarms was reduced to 3 for the first dataset and zero for the second dataset, demonstrating the effectiveness of the post-processing in reducing false positives.

Table 1 shows the false positive rate for the second simulation before and after post-processing.

TABLE 1
Comparison of false positive rate before and after post-processing

False positive Rates

| | First | Second |
|---|---|---|
| Before Post-Processing | 0.476% | 0.002% |
| After Post-Processing | 0.005% | 0% |

A comparative analysis was conducted between the model described herein (CB-AttentionNet) and established leak detection models that had previously demonstrated efficacy in leak detection (LSTM Autoencoder (AE), Fully Linear DenseNet (FL-DenseNet), CNN-LSTM, and LSTM attention mechanism (AM)). As a baseline, the model without attention mechanisms (1DCNN-BiLSTM) was also considered. To ensure a fair comparison, all models were trained on the same dataset. Table 2 showcases the performance metrics—Accuracy, Precision, Recall, and F1 Score—of these models.

TABLE 2
Comparison of Performance Metrics for Three
Different Models in Simulations 1 and 2

| | | Performance Metrics | | | |
|---|---|---|---|---|---|
| Simulations | Model | Accuracy | Precision | Recall | F1 Score |
| Simulation 1 | CB- | 0.958 | 0.99 | 0.89 | 0.936 |
| | AttentionNet | | | | |
| | LSTM AE | 0.90 | 0.91 | 0.91 | 0.89 |
| | FL-DenseNet | 0.86 | 0.86 | 0.85 | 0.855 |
| | CNN-LSTM | 0.91 | 0.86 | 0.90 | 0.88 |
| | LSTM AM | 0.94 | 0.92 | 0.96 | 0.94 |
| Simulation 2 | CB- | 0.96 | 0.999 | 0.937 | 0.961 |
| | AttentionNet | | | | |
| | LSTM AE | 0.90 | 0.88 | 0.90 | 0.89 |
| | FL-DenseNet | 0.88 | 0.86 | 0.88 | 0.87 |
| | CNN-LSTM | 0.94 | 0.94 | 0.87 | 0.904 |
| | LSTM AM | 0.96 | 0.95 | 0.96 | 0.95 |

In evaluating the second simulations involving site activities, the False Positive Rates (FPRs) among these models were specifically compared, as shown in Table 3. The primary objective was not only to detect leaks effectively but also to minimize the occurrence of false alarms.

The wide range of signal-capturing technologies makes evaluating leak detections challenging. To evaluate the model's effectiveness, it was compared with other methodologies that have previously proven effective. All models were trained on the dataset, segmented into one-minute data windows. When using the model with the attention mechanism, a significant reduction in false alarm rate was demonstrated compared with the CNN-LSTM model, dropping from 0.04% to 0.006%. Although both models achieved nearly identical accuracy, the substantial difference in false positives indicates the present model's ability to effectively minimize false alarms, suggesting its potential superiority in leak detection.

TABLE 3
Comparison of FPR for Three Different
Models in Simulations 1 and 2

| | CB- | LSTM | LSTM | FL- | |
|---|---|---|---|---|---|
| | AttentionNet | AE | AM | DenseNet | DLNN |
| FPR | 0.002% | 0.12% | 0.13% | 0.08% | 0.04% |

The FL-DenseNet is a variant of DenseNet. The growth rate and the number of layers within each dense block were set to 12 and 4, respectively, and the number of kernels was set to 3 in accordance with the model. The LSTM AE and LSTM AM models both have 4 layers and 64 hidden layers. The attention component of the LSTM AM model clearly affected the number of false negatives when compared to the LSTM AE model. Overall, while maintaining relative simplicity, the present model (CB-AttentionNet) outperformed other models, demonstrating superior overall performance in terms of precision, recall, and false positive rates, as shown in Tables 2 and 3.

The model described herein demonstrates significant advantages in leak detection for pipelines. By integrating a 1D CNN for local pattern extraction, a BiLSTM for capturing temporal dependencies, and an attention mechanism for emphasizing critical information, the model achieves high accuracy, precision, and recall rates while maintaining low false positive rates. The post-processing technique described herein may further enhance the model's reliability, ensuring that detected leaks are consistently verified. Compared with traditional models, the CB-AttentionNet model effectively balances the detection of true positives and the reduction of false alarms, making it a robust and efficient solution for real-time pipeline monitoring and anomaly detection.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or part of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

It should be understood that various modifications, alterations, and adaptations may be made to the specific elements and configurations disclosed, including but not limited to dimensions, materials, positions, and operational mechanisms, without departing from the essence and scope of the disclosure.

The terminology used herein is only for the purpose of describing particular embodiments and is not intended to be limiting. Accordingly, as used herein, the singular forms “a”, “an”, and “the” are intended to include the plural forms as well, unless the context clearly indicates otherwise. It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections.

Use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

It is contemplated that any part of any aspect or embodiment discussed in this specification can be implemented or combined with any part of any other aspect or embodiment discussed in this specification, so long as such those parts are not mutually exclusive with each other.

While every effort has been made to provide a detailed and accurate description of the disclosure herein, it should be noted that the scope of the disclosure is not limited to the exact configurations and embodiments described. The description provided is intended to illustrate the principles of the disclosure and not to limit the disclosure to the specific embodiments illustrated. It is intended that the scope of the disclosure be defined by the appended claims, their equivalents, and their potential applications in other fields.

1. A method comprising:
receiving a detection signal from a sensor deployed along a pipeline;
inputting the detection signal to an artificial neural network comprising:
a feature extraction model that extracts from the detection signal a feature map that represents one or more patterns along a temporal dimension represented by a plurality of temporal stamps;
a temporal processing model that generates from the feature map a plurality of states that capture temporal dependencies, wherein each of the plurality of states corresponds to one of the plurality of temporal stamps, and wherein the temporal dependencies represent an influence on one of the plurality of states by at least another of the plurality of states; and
a weighting model that assigns a weight to each of the plurality of states to generate weighted representations of the plurality of states using an attention mechanism; and
obtaining a detection result from the artificial neural network,
wherein prior to receiving the detection signal, the artificial neural network has been trained to generate the detection result from the plurality of states using a training dataset comprising training signals representative of anomalies and non-anomalies in respect of the pipeline, and wherein a set of data from the training signals is labeled with a leak.

2. The method of claim 1, wherein the detection result is either leak or non-leak, and wherein data in the training dataset labeled with the non-anomaly comprises a first set of data labeled with a non-leak activity and a second set of data labeled with noise.

3. The method of claim 1, wherein the weighting model comprises a plurality of attention heads, each head configured to:
calculate one or more attention scores for each of the plurality of states;
normalize the one or more attention scores using a softmax function;
generate one or more weights from the normalized one or more attention scores; and
generate weighted representations of the plurality of states using the one or more weights.

4. The method of claim 3, wherein the weighted representations from each of the plurality of attention heads are combined to form an aggregated representation, the aggregated representation being used to update the plurality of states.

5. The method of claim 4, wherein the weighted representations are averaged using a mean function, and wherein an output of the mean function is passed through a linear layer that applies a linear transformation prior to obtaining the detection result.

6. The method of claim 1, further comprising:
storing the detection result in a buffer over time as a plurality of iterations;
outputting the detection result as a presence of the anomaly in response to the plurality of iterations having identified the anomaly at least a predetermined threshold number of times.

7. The method of claim 1, wherein the detection signal is an acoustic signal detected at one or more channels of the sensor divided for the pipeline, and wherein the sensor is an optical sensor configured to capture at least one of temperature and strain measurements at the one or more channels of the sensor.

8. The method of claim 1, wherein the feature extraction model is a one-dimensional convolutional neural network (1D CNN), and the method further comprises formatting the detection signal into one-dimensional sequential data.

9. The method of claim 1, wherein the temporal processing model is a bidirectional long short-term memory (BiLSTM) network, the plurality of states are hidden states of the BiLSTM network, and the plurality of states are concatenated outputs of a forward BiLSTM layer and a backward BiLSTM layer of the BiLSTM network.

10. The method of claim 1, wherein the feature extraction model further divides the detection signal into a plurality of windows using a sliding-time window technique, each window comprising a segment of the detection signal spanning a specific length of time defined by the plurality of temporal stamps, and wherein a 1D CNN is applied to each of the plurality of windows on a per-window basis to extract the feature map.

11. A method comprising:
providing a training dataset of a detection signal from a sensor deployed along a pipeline to an artificial neural network, the training dataset comprising training signals representative of anomalies and non-anomalies in respect of the pipeline, wherein the artificial neural network comprises:
a feature extraction model that extracts from the detection signal a feature map that represents one or more patterns along a temporal dimension represented by a plurality of temporal stamps;
a temporal processing model that generates from the feature map a plurality of states that capture temporal dependencies, wherein each of the plurality of states corresponds to one of the plurality of temporal stamps, and wherein the temporal dependencies represent an influence on one of the plurality of states by at least one other of the plurality of states; and
a weighting model that assigns a weight to each of the plurality of states to generate weighted representations of the plurality of states using an attention mechanism; and
training, by using the training dataset, the artificial neural network to generate a detection result from the plurality of states using the training dataset.

12. The method of claim 11, wherein the detection result is either leak or non-leak, and wherein data in the training dataset labeled with the non-anomaly comprises a first set of data labeled with a non-leak activity and a second set of data labeled with noise.

13. The method of claim 11, wherein the weighting model comprises a plurality of attention heads, each head configured to:
calculate one or more attention scores for each of the plurality of states;
normalize the one or more attention scores using a softmax function;
generate one or more weights from the normalized one or more attention scores; and
generate weighted representations of the plurality of states using the one or more weights.

14. The method of claim 13, wherein the weighted representations from each of the plurality of attention heads are combined to form an aggregated representation, the aggregated representation being used to update the plurality of states.

15. The method of claim 14, wherein the weighted representations are averaged using a mean function, and wherein an output of the mean function is passed through a linear layer that applies a linear transformation prior to obtaining the detection result.

16. The method of claim 11, wherein the detection signal is an acoustic signal detected at one or more channels of the sensor divided for the pipeline, and wherein the sensor is an optical sensor configured to capture at least one of temperature and strain measurements at the one or more channels of the sensor.

17. The method of claim 11, wherein the feature extraction model is a one-dimensional convolutional neural network (1D CNN), and the detection signal is formatted into one-dimensional sequential data.

18. The method of claim 11, wherein the temporal processing model is a bidirectional long short-term memory (BiLSTM) network, the plurality of states are hidden states of the BiLSTM network, and the plurality of states are concatenated outputs of a forward BiLSTM layer and a backward BiLSTM layer of the BiLSTM network.

19. The method of claim 11, wherein the feature extraction model further divides the detection signal into a plurality of windows using a sliding-time window technique, each window comprising a segment of the detection signal spanning a specific length of time defined by the plurality of temporal stamps, and wherein a 1D CNN is applied to each of the plurality of windows on a per-window basis to extract the feature map.

20. A system for detecting anomalies in a pipeline, comprising:
a sensor deployed along the pipeline, configured to generate and transmit a detection signal;
an artificial neural network configured to receive the detection signal, the artificial neural network comprising:
a feature extraction model that extracts from the detection signal a feature map that represents one or more patterns along a temporal dimension represented by a plurality of temporal stamps;
a temporal processing model that generates from the feature map a plurality of states that capture temporal dependencies, wherein each of the plurality of states corresponds to one of the plurality of temporal stamps, and wherein the temporal dependencies represent an influence on one of the plurality of states by at least another of the plurality of states; and
a weighting model that assigns a weight to each of the plurality of states to generate weighted representations of the plurality of states using an attention mechanism,
wherein the artificial neural network is trained prior to receiving the detection signal to generate a detection result from the plurality of states using a training dataset comprising training signals representative of anomalies and non-anomalies in respect of the pipeline, and wherein a set of data from the training signals is labeled with a leak; and
an output module configured to obtain the detection result from the artificial neural network.

21. A non-transitory computer-readable medium having instructions stored thereon, the instructions configured when read by a computer to cause the computer to perform a method comprising:
receiving a detection signal from a sensor deployed along a pipeline;
inputting the detection signal to an artificial neural network comprising:
a feature extraction model that extracts from the detection signal a feature map that represents one or more patterns along a temporal dimension represented by a plurality of temporal stamps;
a temporal processing model that generates from the feature map a plurality of states that capture temporal dependencies, wherein each of the plurality of states corresponds to one of the plurality of temporal stamps, and wherein the temporal dependencies represent an influence on one of the plurality of states by at least another of the plurality of states; and
a weighting model that assigns a weight to each of the plurality of states to generate weighted representations of the plurality of states using an attention mechanism; and
obtaining a detection result from the artificial neural network,
wherein prior to receiving the detection signal, the artificial neural network has been trained to generate the detection result from the plurality of states using a training dataset comprising training signals representative of anomalies and non-anomalies in respect of the pipeline, and wherein a set of data from the training signals is labeled with a leak.
